(19) United States
(12) Patent Application Publication
(10) Pub. No.: US 2004/0140843 A1
(43) Pub. Date: Jul. 22, 2004

(54) Integrator circuit

(76) Inventor: Thomas A. Rodby, Palm Bay, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/751,385

(22) Filed: Jan. 5, 2004

Related U.S. Application Data
(60) Provisional application No. 60/438,153, filed on Jan. 6, 2003.

(51) Int. Cl. G06G 7/18

(52) U.S. Cl. 327/336

(57) ABSTRACT

An integrator circuit comprises an operational amplifier having its inverting input coupled to an input resistor to which an input voltage is supplied, and its non-inverting input coupled to a reference potential. A capacitor and a first output resistor are coupled in series between the inverting input terminal and the output terminal, from which an output voltage is derived. A second output resistor is coupled between the reference potential and the connection of the capacitor and the first output resistor. The addition of the two output resistors makes it possible to easily realize a desired integration constant with the use of a larger fixed capacitor, thereby minimizing unwanted parasitic capacitor effects. The integration constant can be adjusted as necessary by making the output resistors variable.

### CROSS-REFERENCE TO RELATED APPLICATION

The present application claims the benefit of co-pending U.S. application Ser. No. 60/438,153, filed Jan. 6, 2003, by Thomas A. Rodby, entitled: “Integrator Circuit,” the disclosure of which is incorporated herein.

### FIELD OF THE INVENTION

The present invention relates in general to electronic circuits, and is particularly directed to a new and improved integrator circuit that incorporate a pair of auxiliary/output resistors in the output feedback path of the integrator, that make it possible to more easily realize a desired integration constant with the use of a larger fixed capacitor, thereby minimizing unwanted parasitic capacitor effects. Also, the integration constant can be readily adjusted by implementing the auxiliary resistors as variable components.

### BACKGROUND OF THE INVENTION

Integrator circuits are employed in a wide variety of electronic signal processing applications, such as, but not limited to the analog front ends of electrical signal detection and monitoring systems (for example, lightning detection systems). As shown in FIG. 1, the basic configuration of a conventional integrator circuit comprises an operational amplifier 10 and a capacitor 15. In the architecture of FIG. 1, the operational amplifier 10 has its inverting (−) input 11 coupled to receive an input current IIN, while its non-inverting (+) input 12 is coupled to a reference potential (ground) Capacitor 15 is coupled between input 11 and the amplifier output 13 from which an output voltage V_{OUT} is derived. The transfer function of the integrator of FIG. 1 is set forth in equation (1) as:

V_{OUT}(t)=V₀−(1/C)∫I _{IN}(t)dt (1)

From equation (1) it can be seen that the integration constant is inversely proportional to the value (C) of the capacitor 15.

FIG. 2 shows a typical variation of the integrator circuit of FIG. 1 to accept a voltage input V_{IN}, wherein an input resistor 16 of value R is coupled to the inverting (−) input 11 of the operational amplifier 10. The transfer function of the integrator of FIG. 2 is set forth in equation (2) as:

V_{OUT}(t)=V₀−(1/RC)∫V_{IN}(t) dt (2)

From equation (2) it can be seen that a much larger variation of the integration constant (1/RC) is available, as two variables R and C can be varied. However, the input resistor is normally selected to provide a prescribed input impedance, so that it is the value of the capacitor that must be varied to realize a given integration constant. A practical problem of the circuit design of FIG. 2 is the fact that the capacitor used to set the integration constant is typically available in only discrete values. Therefore, to realize a non-standard value of capacitance for creating a specific integration constant, a plurality of capacitors must be employed. Where a large integration constant is required, it is customary to use a small value of capacitance. When configuring the circuit of FIG. 2 with small capacitance values, the impact of parasitic capacitances on circuit performance becomes a design issue.

### SUMMARY OF THE INVENTION

In accordance with the present invention, the capacitor-centric problem of a conventional integrator, described above, is effectively obviated by a new and improved integrator design that couples a set of auxiliary/output resistors in the output feedback path of the integrator of FIG. 2. In particular, a first auxiliary resistor is coupled in series with the output of the operational amplifier and the feedback capacitor, while a second auxiliary resistor is coupled between a reference potential terminal (e.g. ground) and the common connection of the first auxiliary resistor and the feedback capacitor. As a result of incorporation of the auxiliary set of resistors, the integrator of the invention has the transfer function set forth in equation (3) as follows:

V_{OUT}(t)=V₀−((R₂+R₃)/R₁R₂C))∫V_{IN}(t)dt (3)

where R₁ corresponds to the value of the input resistor, R₂ corresponds to the value of the first auxiliary resistor, and R₃ corresponds to the value of the second auxiliary resistor. As in the case of the circuit of FIG. 2, the input impedance of the integrator circuit of the invention is set by the value of the input resistor R1. However, the integration constant now has a pair of additional variables R₂ and R₃ that allow the circuit designer a greater degree of flexibility. This can be particularly advantageous in applications, such as in lightning detection systems, where a change in integration constant may be required (for example, in the case of an approaching storm, it may be desirable to decrease the gain of the integrator, as the storm gets closer to the monitoring site). This is readily accomplished in the integrator of the invention, by using variable resistors, such as potentiometers, for the auxiliary resistors.

### BRIEF DESCRIPTION OF THE DRAWINGS

FIG. 1 shows the basic configuration of a conventional integrator circuit;

FIG. 2 shows a typical variation of the integrator circuit of FIG. 1 to accept a voltage input; and

FIG. 3 shows the architecture of the integrator circuit of the present invention.

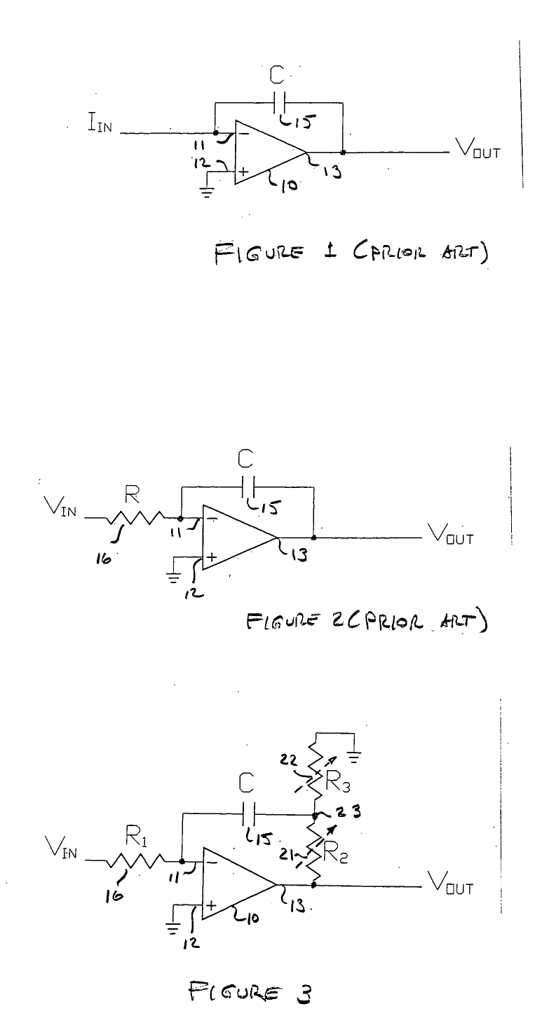

### DETAILED DESCRIPTION

Attention is now directed to FIG. 3, wherein a voltage input integrator architecture in accordance with the present invention is diagrammatically illustrated as comprising an operational amplifier 10 having its inverting (−) input coupled through an input resistor 16 of value R₁ to receive an input voltage V_{IN}, and its non-inverting (+) input 12 coupled to a source of reference potential (e.g., ground). An output voltage V_{OUT} is derived from the output 13 of the operational amplifier. Pursuant to the present invention, rather than directly couple feedback capacitor 15 between the output and the input of the operational amplifier, as in the conventional integrator of FIG. 2, the feedback path is modified to include a first auxiliary/output resistor 21 of a value R₂, which is coupled in series with capacitor 15 and the operational amplifier output 13. In addition, a second auxiliary/output resistor 22 of value R₃ is coupled between a reference potential (ground) and the common connection 23 of capacitor 15 and auxiliary/output resistor 21.

As pointed out above, the transfer function of the integrator architecture of FIG. 3 is defined by equation (3), restated as follows:

V_{OUT}(t)=V₀−((R₂+R₃)/R₁R₂C))∫V_{IN}(t)dt (3)

With the addition of the auxiliary/output resistors 21 and 22, the present invention makes it possible to more easily realize a desired integration constant with the use of a larger fixed capacitor, thereby minimizing unwanted parasitic capacitor effects, described above. Moreover, the integration constant can be readily adjusted as necessary by implementing the auxiliary resistors as variable components (as shown by the dotted line arrows), such as potentiometers or electronically controlled resistors, such as MOSFETs.

While I have shown and described an embodiment in accordance with the present invention, it is to be understood that the same is not limited thereto but is susceptible to numerous changes and modifications as known to a person skilled in the art. I therefore do not wish to be limited to the details shown and described herein, but intend to cover all such changes and modifications as are obvious to one of ordinary skill in the art.

What is claimed:

1. An integrator circuit comprising:
an input port;
an output port;
an operational amplifier having an input terminal coupled through an input resistor to said input port and having an output terminal coupled to said output port;
a capacitor and a first output resistor coupled in series between said input terminal and said output terminal of said operational amplifier; and
a second output resistor coupled between a reference potential terminal and a common connection of said capacitor and said first output resistor.

2. The integrator circuit according to claim 1, wherein at least one of said first and second output resistors is adjustable.

3. The integrator circuit according to claim 1, wherein at each of said first and second output resistors is adjustable.

4. An integrator circuit comprising:
an operational amplifier having an inverting input coupled to an input resistor to which an input voltage is supplied, a non-inverting input coupled to a reference potential, and an output from which an output voltage is derived;
a capacitor and a first output resistor coupled in series between said inverting input and said output of said operational amplifier; and
a second output resistor coupled between said reference potential and a common connection of said capacitor and said first output resistor.

5. The integrator circuit according to claim 4, wherein at least one of said first and second output resistors is adjustable.

6. The integrator circuit according to claim 4, wherein at each of said first and second output resistors is adjustable.
